(19) United States
(12) Patent Application Publication
(10) Pub. No.: US 2025/0294395 A1
(43) Pub. Date: Sep. 18, 2025

(54) Wireless Audio Data Transmission Method, Scalable Controller and Receiving Device

(71) Applicant: Zgmicro Wuxi Corporation, Wuxi (CN)

(72) Inventors: Bin XU, Hefei (CN); David Xiaodong YANG, Wuxi (CN)

(21) Appl. No.: 19/080,936

(22) Filed: Mar. 17, 2025

(30) Foreign Application Priority Data
Mar. 15, 2024 (CN) 2024103025979

(51) Int. Cl. H04W 24/10; H04R 3/00; H04W 84/18

(52) U.S. Cl. CPC H04W 24/10; H04R 3/00; H04W 84/18; H04R 2420/07

(57) ABSTRACT

The present invention provides a wireless audio data transmission method, a scalable controller, and a receiving device. This method is applied to a scalable controller that consists of a master controller and at least one slave controller. The method comprises: operating the scalable controller in a first working mode during isochronous stream audio transmission; receiving, by the master controller, a first audio data packet transmitted by an audio transmitting device when the master controller is enabled and obtaining, by the master controller, the reception status of the first audio data packet from at least one enabled slave controller; determining, by the master controller, a target first audio data packet based on the reception status of the first audio data packet received by the master controller and the reception status reported by the enabled slave controller; and reporting, by the master controller, the target first audio data packet to a host processor. This method increases the equivalent number of retransmissions, enhancing communication performance and improving the transmission reliability of isochronous stream audio. Additionally, it achieves these benefits without requiring significant modifications to the transmitting device or chip designs.

### CROSS REFERENCE OF RELATED APPLICATIONS

The present invention claims priorities of Chinese Patent Application No. 2024103025979 filed in China on Mar. 15, 2024, the entire contents of which are incorporated herein by reference.

### FIELD OF THE INVENTION

The present invention relates to the field of wireless communication technologies, specifically to a wireless audio data transmission method, a scalable controller, and a receiving device.

### BACKGROUND

Bluetooth Low Energy (BLE) Audio technology utilizes Isochronous Channels protocols, which includes: a Connected Isochronous Stream (CIS) link—Supports point-to-point communication; a Connected Isochronous Group (CIG) link protocol—Composed of at least one CIS link; a Broadcast Isochronous Stream (BIS) link—Supports point-to-multipoint communication; and a Broadcast Isochronous Group (BIG) link protocol—Composed of at least one BIS link. This technology enables wireless audio services with lower power consumption, reduced costs, lower latency, improved quality, and greater versatility. For example: a Wireless Broadcast Audio (WBA) function for point-to-multipoint communication is implemented using the BIG link protocol; and a Wireless Low Latency Audio (WLLA) function for point-to-point communication is implemented using the CIG link protocol.

Despite its advantages, WBA and WLLA functions face performance limitations due to the restricted number of retransmissions in environments with fading or interference. For instance, In WBA functions based on the BIG link, using an A2DP Classic BT or Wi-Fi audio source, the BIG master device's transmission time slots must coexist with the transmitting/receiving time slots of A2DP or Wi-Fi audio sources in a timesharing manner. This prevents an increase in BIG retransmissions, resulting in unsatisfactory performance. In particular, on high-definition audio broadcasting, the limited number of BIG retransmissions further degrades WBA performance, making it unsuitable for applications with higher performance requirements. In one example, in WLLA functions, ensuring low latency by using a very small CIG isochronous interval limits the ability to increase retransmissions, further reducing WLLA performance. In another example, for low-latency audio requiring a high sampling rate and high coding rate, the restricted number of CIG retransmissions makes WLLA performance even more difficult to optimize.

To address these retransmission limitations in BIG and CIG, existing solutions include: Multichannel-based multi-transmitting device technology, and Multi-radio frequency-based multi-receiving path technology. However, these approaches require significant modifications to the transmitting device or chip design, leading to increased chip development costs.

### SUMMARY OF THE INVENTION

The present invention provides a wireless audio data transmission method, a scalable controller, and a receiving device, aimed at improving communication performance under limited retransmission conditions.

To achieve this goal, in an embodiment, the invention provides a wireless audio data transmission method applied to a scalable controller, which consists of a master controller and at least one slave controller. The method includes the following steps: operating the scalable controller in a first working mode during isochronous stream audio transmission; receiving, by the master controller, a first audio data packet transmitted by an audio transmitting device when the master controller is enabled, and obtaining, by the master controller, a reception status of the first audio data packet from at least one slave controller that is enabled to receive synchronously the first audio data packet transmitted by the audio transmitting device and report the reception status of the first audio data packet to the master controller; determining, by the master controller, a target first audio data packet based on a reception status of the first audio data packet of the master controller, and the reception status reported by the enabled slave controller, the target first audio data packet being the first audio data packet that is correctly received; and reporting, by the master controller, the target first audio data packet to a host processor.

In an embodiment of the invention a scalable controller is described, the scalable controller consisting of: a master controller and at least one slave controller, wherein the master control comprises a first interface and a second interface defined by a Bluetooth Core Specification, the first interface is configured to connect to a host processor located outside the scalable controller, and the second interface is configured to connect to the at least one slave controller; the master controller is provided with one or more corresponding antennas configured to receive an audio data packet transmitted by an audio transmitting device, and each slave controller is provided with one or more corresponding antennas configured to receive the audio data packet transmitted by the audio transmitting device, wherein the antennas of the master controller are spatially separated from the antennas of each slave controller, both the master controller and each slave controller comprise a radio frequency unit, a modulation and demodulation unit, a baseband processor, a link protocol processor and a memory.

In an embodiment, the master controller is configured for: operating the scalable controller in a first working mode during isochronous stream audio transmission; receiving a first audio data packet transmitted by the audio transmitting device when the master controller is enabled, and obtaining a reception status of the first audio data packet from at least one slave controller that is enabled to receive synchronously the first audio data packet transmitted by the audio transmitting device and report the reception status of the first audio data packet to the master controller; determining a target first audio data packet based on a reception status of the first audio data packet of the master controller, and the reception status reported by the enabled slave controller, the target first audio data packet being the first audio data packet that is correctly received; and reporting the target first audio data packet to a host processor.

In an embodiment, a receiving device is described, the receiving device comprising: a host processor; and a scalable controller connected to the host processor via a first interface defined by a Bluetooth Core Specification, wherein the scalable controller comprises a master controller and at least one slave controller and is configured for: operating the scalable controller in a first working mode during isochronous stream audio transmission; receiving a first audio data packet transmitted by the audio transmitting device when the master controller is enabled, and obtaining a reception status of the first audio data packet from at least one slave controller that is enabled to receive synchronously the first audio data packet transmitted by the audio transmitting device and report the reception status of the first audio data packet to the master controller; determining a target first audio data packet based on a reception status of the first audio data packet of the master controller, and the reception status reported by the enabled slave controller, the target first audio data packet being the first audio data packet that is correctly received; and reporting the target first audio data packet to a host processor; and the host processor is configured to receive the target audio data packet transmitted by the scalable controller via the first interface.

In an embodiment, a method of operating a scalable controller, wherein the scalable controller includes a master controller and at least one slave controller, the method comprising: operating the scalable controller in the first working mode during isochronous stream audio transmission; receiving a first audio data packet from the audio transmitting device when the master controller is enabled; obtaining the reception status of the first audio data packet from at least one enabled slave controller; determining the target first audio data packet based on the reception status of the master and slave controllers; and reporting the target first audio data packet to the host processor. The host processor is responsible for receiving the target audio data packet transmitted by the scalable controller via the first interface.

The present invention provides a wireless audio data transmission method, a scalable controller, and a receiving device. The scalable controller adaptively utilizes one or more slave controllers to assist the master controller in receiving isochronous stream audio data packets from the audio transmitting device. By distributing reception tasks across multiple controllers, this method: increases the number of equivalent retransmissions; enhances communication performance; and improves transmission reliability for isochronous stream audio.

In addition, this method does not require significant modifications to the transmitting device or the chip design, and has better scalability. That is, one or more slave controllers can be expanded according to the performance requirements to assist the master controller in receiving the isochronous stream audio data packets, and one or more controllers can be adaptively enabled to receive the isochronous stream audio data packets according to the changes in the communication environment.

There are many additional objectives and advantages of this invention, which will become apparent in the following descriptions and in the embodiments illustrated in the accompanying drawings.

### BRIEF DESCRIPTION OF THE DRAWINGS

These and other features, aspects, and advantages of the present invention will become better understood with regard to the following description, appended claims, and accompanying drawings wherein:

FIG. 1 illustrates an exemplary schematic structural diagram of a WBA (Wireless Broadband Audio) system based on a Broadcast Isochronous Group (BIG) link according to one embodiment of the present invention;

FIG. 2 illustrates an exemplary schematic structural diagram of a WLLA (Wireless Low Latency Audio) system based on a Connected Isochronous Group (CIG) link according to one embodiment of the present invention;

FIG. 3 illustrates an exemplary schematic structural diagram of an SCISA (Scalable Controllers for Isochronous Stream Audio) receiving device according to one embodiment of the present invention;

FIG. 4 illustrates an exemplary schematic diagram of a cascaded connection between multiple controllers according to one embodiment of the present invention;

FIG. 5 illustrates an exemplary schematic diagram of a parallel connection between multiple controllers according to one embodiment of the present invention;

FIG. 6 illustrates an exemplary timing diagram illustrating A2DP (Advanced Audio Distribution Profile) and BIG operations of a WBA master device according to one embodiment of the present invention;

FIG. 7 illustrates an exemplary flowchart of a wireless audio data transmission method according to one embodiment of the present invention;

FIG. 8 illustrates an additional exemplary flowchart of a wireless audio data transmission method according to another embodiment of the present invention;

FIG. 9 illustrates an exemplary timing diagram illustrating CIG operations in the WLLA system according to one embodiment of the present invention;

FIG. 10 illustrates an exemplary schematic structural diagram of a controller according to one embodiment of the present invention; and

FIG. 11 illustrates an exemplary block diagram of a wireless audio data transmission device according to one embodiment of the present invention.

### DETAILED DESCRIPTION OF THE PREFERRED EMBODIMENTS

The detailed description of the invention is primarily presented in terms of procedures, operations, logic blocks, processing, and symbolic representations that resemble the functions of data processing devices, whether or not they are networked. These descriptions and representations are commonly used by those skilled in the art to effectively communicate technical concepts.

References to “one embodiment” or “an embodiment” indicate that a particular feature, structure, or characteristic described in connection with the embodiment is included in at least one version of the invention. The phrase “in one embodiment” does not necessarily refer to the same embodiment throughout the specification, nor are separate embodiments mutually exclusive. Additionally, the sequence of blocks in process flowcharts or diagrams does not inherently dictate a specific order or impose limitations on the invention.

The following provides a detailed explanation of a wireless audio data transmission method according to one embodiment of the present invention, along with its application scenarios, as illustrated in the accompanying drawings.

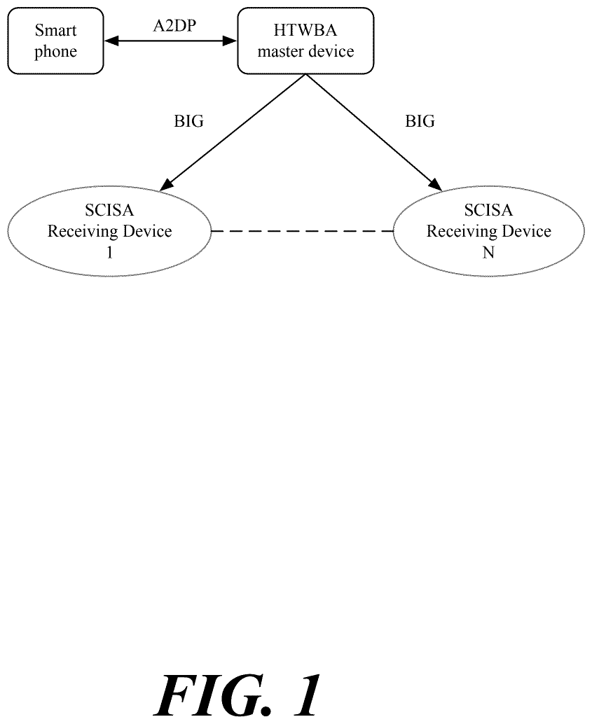

For illustrative purposes but not meant to be limiting, an application scenario practicing the invention described herein is provided. Referring to FIG. 1, which illustrates a structural diagram of a WBA system based on a BIG link according to one embodiment of the present invention, the WBA system includes a WBA master device and one or more SCISA receiving devices, where N≥1 and is a positive integer. A smartphone communicates with the WBA master device using a Classic Bluetooth Advanced Audio Distribution Profile (A2DP) link.

The WBA system may also include one or more standard WBA slave devices. However, for the purposes of this description, only the SCISA receiving device is discussed. The WBA master device serves as a Classic Bluetooth A2DP wireless audio source. As shown in FIG. 1, the WBA master device receives audio data from the smartphone through the A2DP link and then transmits it to SCISA receiving devices via the BIG link.

Optionally, the WBA master device may also function as a BIG master device, while the SCISA receiving device may serve as a BIG slave device, a WBA slave device, or an SCISA slave device.

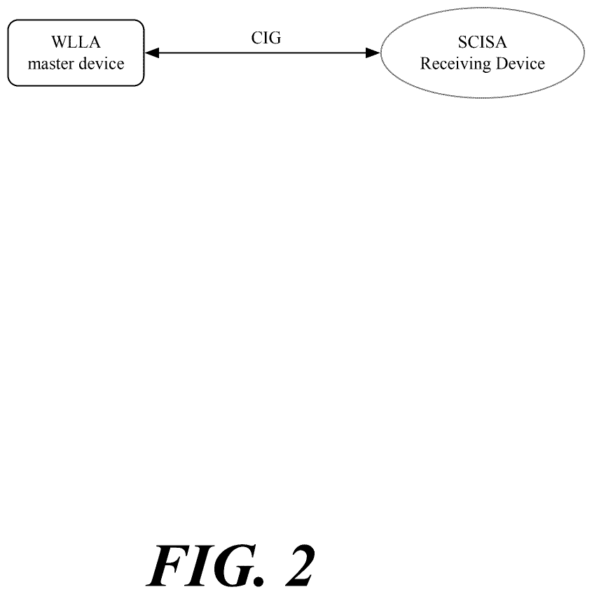

Referring to FIG. 2, which illustrates a structural diagram of a WLLA system based on a CIG link according to another embodiment of the present invention. The WLLA system consists of a WLLA master device and an SCISA receiving device. The WLLA master device transmits audio data to the SCISA receiving device through the CIG link. Optionally, the WLLA master device may also function as a CIG master device, while the SCISA receiving device may serve as a CIG slave device, a WLLA slave device, or an SCISA slave device.

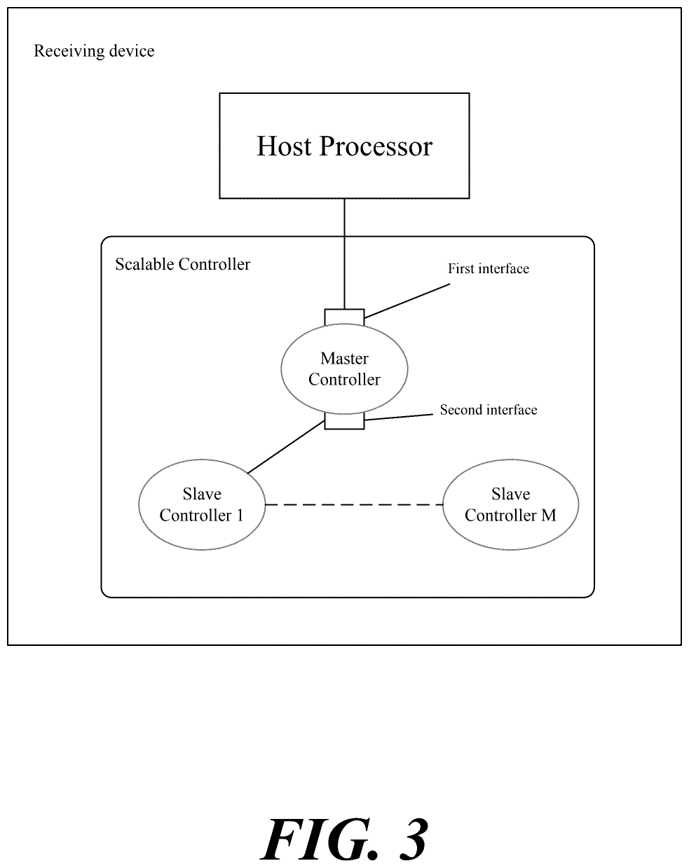

As shown in FIG. 3, which presents a schematic structural diagram of an SCISA receiving device according to one embodiment of the present invention, the SCISA receiving device employs a scalable controller architecture. Specifically, the SCISA receiving device consists of a host processor and a scalable controller, which includes a master controller and one or more scalable slave controllers.

A master-slave interface, as defined by the Bluetooth (BT) Core Specification-such as a Host Controller Interface (HCl)—is used to connect the host processor and the master controller. The physical interface of the HCl may be UART, USB, or SDIO, among others.

The master controller features a first interface and a second interface, both defined by the Bluetooth Core Specification. The first interface connects to the host processor, while the second interface connects to at least one slave controller. Specifically, both interfaces are HCl interfaces.

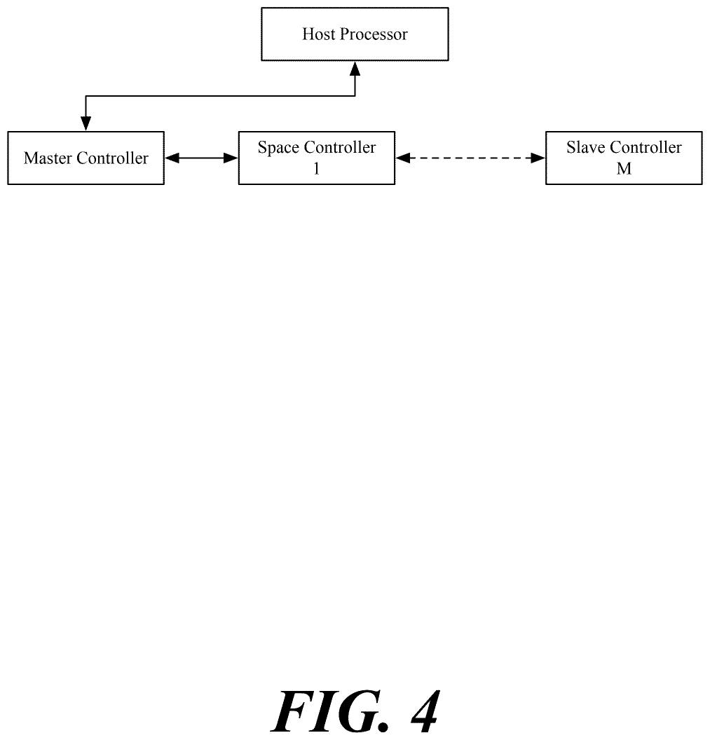

The master controller and slave controllers are connected in a cascaded manner. The physical interface for these connections may be UART, USB, or SDIO. Depending on practical requirements, multiple (M) slave controllers may be cascaded/connected in series, as shown in FIG. 4. Additionally, the multiple slave controllers depicted in FIG. 3 are also arranged in a cascaded/series configuration. For example, at least one slave controller is connected in series to the second interface of the master controller.

To enhance spatial diversity, the master controller and slave controllers are positioned at a sufficient distance from each other, ensuring that the antennas of both remain far enough apart to achieve a low fading correlation coefficient for received signals. Without loss of generality, the controller follows the Bluetooth Core Specification and includes functions such as radio, baseband, link control, link management, and link layer operations.

Additionally, the host processor integrates all other functional modules of the SCISA receiving device, apart from the controllers. Beyond executing host protocols defined by the Bluetooth Core Specification, it also manages configuration protocols, application functions, audio codecs, audio algorithms, and audio input/output operations.

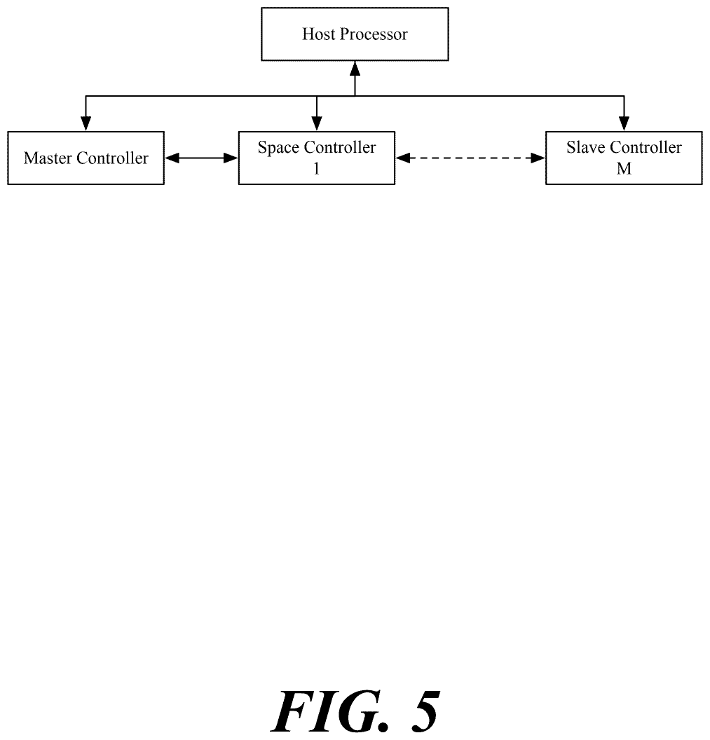

The slave controllers within the scalable controller can also be arranged in a parallel configuration. As shown in FIG. 5, the master controller and the slave controllers (1 to M) are all connected to the host processor. Communication between the host processor and the controllers is established via HCl interfaces as defined by the Bluetooth specification. These interfaces may include UART, USB, or SDIO. Each slave controller, as well as the master controller, is equipped with an HCl interface for connecting to the host processor and transmitting audio data packets.

It is important to note that in the parallel connection mode, the host processor requires additional interfaces to support multiple controllers independently, as there is no need for direct communication between them. In contrast, in the cascaded connection mode, the host processor manages and controls the controllers similarly to conventional WBA or WLLA slave devices. This embodiment is applicable to both cascaded and parallel configurations of SCISA receiving devices. Specifically, the SCISA receiving method applies to SCISA receiving devices utilizing either cascaded or parallel controller connection modes.

Furthermore, in an alternative parallel configuration, the master controller connects to the host processor via an HCl interface while also establishing direct parallel connections with slave controllers 1 through M. In this case, the master controller links to M slave controllers via M independent HCl interfaces, with each slave controller featuring a single dedicated HCl interface.

A SCISA receiving method is illustrated using a SCISA receiving device configured with a cascaded master-slave controller architecture as an example. An isochronous stream audio transmission method, according to one embodiment, leverages the scalable controller structure to adaptively employ one or more slave controllers to assist the master controller in receiving isochronous stream audio data packets. The method, in one embodiment includes, at least: enabling the master controller when the receiving performance of the master controller is sufficiently good; enabling the slave controller when the receiving performance of the slave controller is sufficiently good; and enabling both the master controller and the slave controller when the receiving performance of both the master controller and the slave controller is poor. In this embodiment, the method obtains more equivalent transmission times and improves the communications performance, or the transmission reliability of isochronous stream audio.

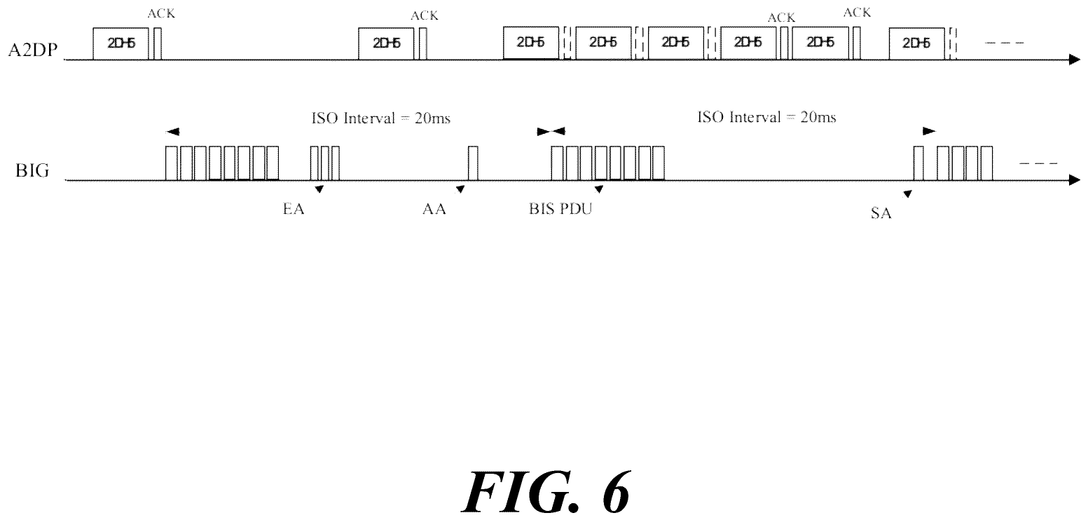

Using an embodiment and an alternate embodiment of the present invention the process can be further illustrated. The first embodiment applies the SCISA receiving method to a WBA system, as shown in FIG. 1. The system utilizes a Classic BT A2DP wireless audio source from a smartphone. The WBA master device's BIG link transmission time slots coexist in a timesharing manner with the transceiver time slots of the A2DP link. FIG. 6 presents a timing diagram of this timesharing coexistence. For clarity, two parallel time axes (representing the same timeline) are shown. One axis represents A2DP transceiver timing, which includes receiving Classic BT 2DH5 packets and sending acknowledgment packets (ACK). The other axis represents the BIG link transmission timing. From the A2DP time axis, it can be seen that the smartphone transmits 2DH5 packets to the WBA master device, which then receives them and sends ACKs back to the smartphone. Meanwhile, on the BIG link time axis, the WBA master device transmits Protocol Data Unit (PDU) packets to the SCISA receiving device. The A2DP transceiver timing and BIG link transmission timing are time-division multiplexed. In other words, when the BIG link is transmitting, the A2DP link cannot perform transceiver operations. In FIG. 6, dashed boxes indicate time slots where ACKs should be sent. However, since the WBA master device did not receive the 2DH5 packets, it does not send the ACKs. To ensure sufficient transceiver time slots for the A2DP link, it becomes challenging to guarantee enough retransmissions for Broadcast Isochronous Stream (BIS) PDUs transmitted over the BIG link.

In an example, after receiving A2DP audio data, the WBA master device first decodes the data, then resamples and reencodes it to meet the BIG link's requirements. The main parameters of the BIG link established by the WBA master device may include, without limitation, at least one of the following: LC3 encoding: 48 kHz sampling rate with a 10 ms frame length; mono encoding rate: 96 kbps; mono Service Data Unit (SDU) size: 120 bytes' BIG isochronous interval (ISO Interval): 20 ms; number of BIS links: 2; number of Sub-Events (NSE): 4; burst Number (BN): 2; immediate Repetition Count (IRC): 2; pre-Transmission Offset (PTO): 0; physical layer: BLE 2 Mbps; periodic advertising interval: 60 ms; and time between the start of periodic advertising and the start of the BIG: 1.25 ms. Each BIS PDU is transmitted only twice—once initially and once as a retransmission. This limited retransmission makes WBA performance susceptible to fading and interference, necessitating an improved reception method for WBA slave devices.

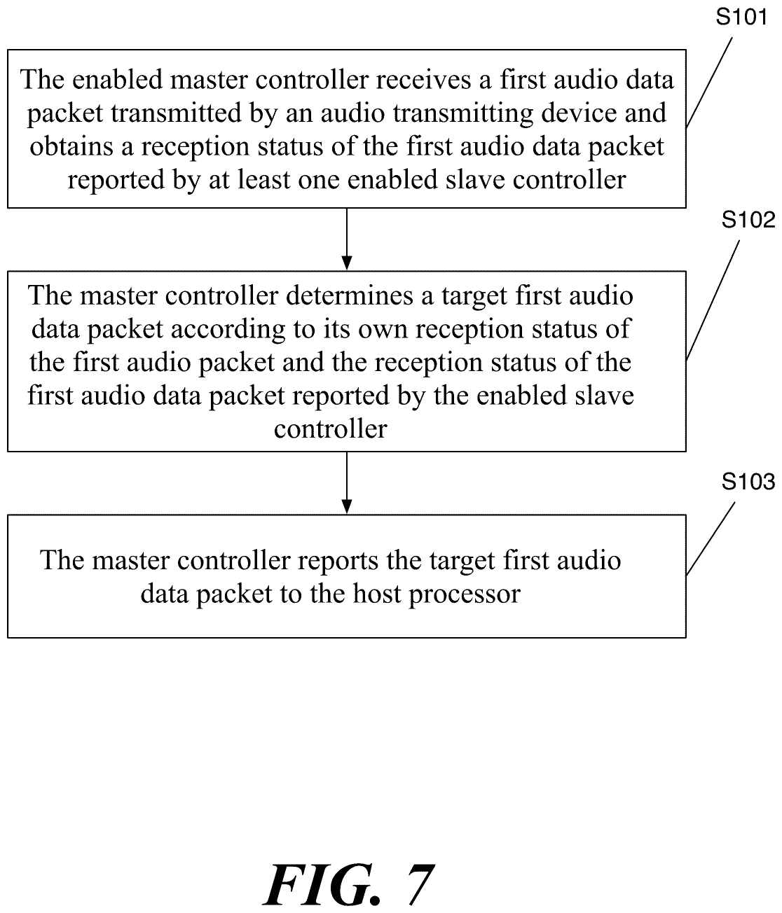

In the first working mode, both the master controller and the slave controller remain synchronized with the WBA master device while simultaneously receiving the BIS PDUs transmitted by the WBA master device. As shown in FIG. 7, one embodiment provides a method for wireless audio data transmission. This method includes the following operations. At step S101, when enabled, the master controller receives a first audio data packet transmitted by an audio transmitting device and obtains the reception status of this packet as reported by at least one enabled slave controller. The audio transmitting device may be the WBA master device, which transmits at least one audio data packet within a single isochronous interval. In the first working mode, this packet is referred to as the first audio data packet. Both the master controller and each enabled slave controller synchronously receive the first audio data packet transmitted by the WBA master device.

When enabled, the slave controller synchronously receives the first audio data packet from the audio transmitting device and reports its reception status to the master controller. The reception status may indicate either successful reception of the first audio data packet or an error in receiving it. Illustratively, ff the first audio data packet is correctly received, the reception status includes the first audio data packet itself, and alternatively if the packet is not received correctly, the reception status contains an indication of the reception failure.

In one embodiment, assuming that Slave Controller 1 is enabled to receive the first audio data packet, the master controller collects its reception status from Slave Controller 1. At operation S102, the master controller determines the target first audio data packet based on both its own reception status and the status reported by the enabled slave controller(s). The target first audio data packet is identified as the correctly received packet.

Operation S102 involves the following alternative scenarios. In a first scenario, the master controller selects its own correctly received packet as the target first audio data packet when the master controller successfully receives the first audio data packet. Alternatively, the master controller selects the packet reported by the slave controller as the target first audio data packet when the master controller does not correctly receive the first audio data packet but the slave controller does correctly receive and reports that status to the master controller. These may be described herein as Scenario 1 and Scenario 2, respectively. Generally, after receiving the first audio data packet from the audio transmitting device, the slave controller performs a Cyclic Redundancy Check (CRC) to verify its integrity. If the packet passes the CRC, the slave controller confirms correct reception and transmits the first audio data packet (such as the BIS PDU) to the master controller via the interface connecting them.

At operation S103, the master controller reports the target first audio data packet to the host processor. In one embodiment, the master controller reports the target first audio data packet to the host processor via the HCl interface.

In the first scenario described above with respect to operation S102, there is a case where both the master controller and the slave controller successfully receive the first audio data packet. When this occurs, the master controller's received packet is selected as the target first audio data packet for reporting, as it has a higher priority than the slave controller. Optionally the first working mode also includes a third alternative, described here as Scenario 3. In this alternative scenario, both the master controller and the enabled slave controller both fail to receive the first audio data packet. In this alternative, the master controller reports an indication to the host processor that the first audio data packet was not successfully receive, meaning that the reception attempt has failed.

When operating in the first working mode, the scalable controller significantly enhances the SCISA receiving device's reception performance. Although both the master and slave controllers typically have only two opportunities to receive the same BIS PDU (IRC=2, PTO=0 for pre-transmission), the SCISA receiving device-comprising both controllers-effectively increases the total reception attempts to four. This is functionally equivalent to an IRC value of 4 with PTO=0, resulting in more retransmission opportunities, which improves communication performance and transmission reliability. Notably, this improvement is achieved without requiring the WBA master device to increase the number of BIS PDU transmissions. Additionally, no modifications are needed to the audio transmitting device or the chip design structure.

In an embodiment, the scalable controller also supports a second working mode for isochronous stream audio transmission, known as the Selective Spatial Diversity mode. Selective Spatial Diversity mode enables either the master controller or one of the slave controllers, depending on the wireless environment. If multiple slave controllers are available, any one of them can be selected to operate. Additionally, the master or slave controller can dynamically switch roles based on wireless channel quality, allowing for adaptive control that optimizes reception and enhances communication reliability through spatial diversity.

This second working mode selectively enables the master controller or a target slave controller to perform the transceiver function for audio data packets based on wireless channel quality. The target slave controller is one of at least one available slave controller. This mode is particularly useful in dynamic wireless environments, where relying solely on the master controller may not meet communication performance requirements, and enabling only the slave controller might provide a better reception alternative.

In Selective Spatial Diversity mode, both the master and slave controllers remain synchronized with the WBA master device. While the master controller synchronizes with the WBA master device and retrieves BIG link information (BIGInfo), it also allows the slave controller to synchronize and obtain BIGInfo through the interface between the master and slave controllers.

More specifically, in this mode, the wireless channel quality between both the master controller and the WBA master device, as well as between the slave controller and the WBA master device, is periodically assessed. This evaluation is typically conducted using the Packet Error Rate (PER) of received BIS PDUs—where a lower PER indicates better channel quality. By default, the master controller is assumed to have the best channel quality and is therefore initially enabled to receive the BIS PDU.

In the second working mode of the wireless audio data transmission method, when the master controller is enabled to receive an audio data packet from the audio transmitting device, it is distinguished from the first working mode's packet and referred to as the second audio data packet (e.g., BIS PDU2). The wireless audio data transmission process in this mode includes the following operations:

Once enabled, the master controller receives the second audio data packet transmitted by the audio transmitting device in the second working mode. The master controller then determines the target second audio data packet based on its reception status. The target second audio data packet is the correctly received data packet transmitted by the audio transmitting device. Since only the master controller is active at this stage, it determines the target packet based on its own reception status and reports it to the host processor.

While the master controller is enabled, real-time channel quality evaluation is performed. If the channel quality meets the first preset condition, the master controller's transceiver function is disabled, and the transceiver function of the target slave controller is enabled. The master controller continues to synchronize with the audio transmitting device and conducts periodic channel quality assessments. The target slave controller is selected from at least one available slave controller.

The first preset condition is defined as follows: the first channel quality (associated with the master controller) falls below a first preset threshold; and the second channel quality (associated with the target slave controller) exceeds a second preset threshold. Generally, the second preset threshold is set higher than the first preset threshold. Optionally, when channel quality is evaluated using the Packet Error Rate (PER), both preset thresholds are defined as the reciprocal of the PER.

In one embodiment, if the master controller is enabled but fails to correctly receive the second audio data packet within one isochronous interval, it reports an indication to the host processor that the second audio data packet was not successfully received. This failure may be due to poor channel quality, leading to packet loss during transmission.

In such cases, if the master controller's channel quality is lower than that of the slave controller, the system selectively enables the slave controller to receive BIS PDU2 while simultaneously disabling the master controller's receiving function. This dynamic switching ensures the reliability of receiving the second audio data packet and optimizes overall system performance.

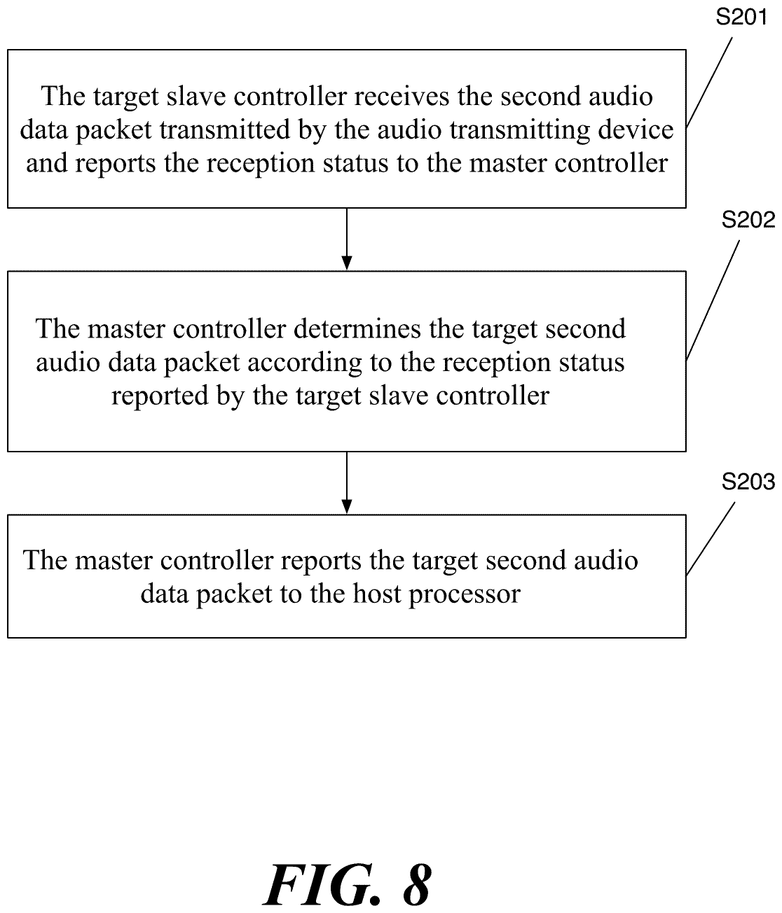

In the second working mode, when the target slave controller is enabled, as illustrated in FIG. 8, the wireless audio data transmission method includes the following operations. At operation S201, the target slave controller receives the second audio data packet from the audio transmitting device and reports its reception status to the master controller at operation S201. The reception status follows the same logic at operation S101, with two possible outcomes: successful reception: The reception status includes the second audio data packet; or unsuccessful reception: The reception status includes an indication that the second audio data packet was not received correctly. The target slave controller transmits its reception status to the master controller via the interface connecting them. The master controller determines the target second audio data packet based on the reception status reported by the target slave controller at operation S202. The target second audio data packet is the version of the second audio data packet that has been correctly received by the target slave controller. If the target slave controller successfully received the second audio data packet, the master controller designates it as the target second audio data packet. If the reported reception status indicates that the second audio data packet was not correctly received, the master controller determines that the target slave controller has failed to receive it, and an indication of incorrect reception is generated. This process ensures that the most reliable version of the second audio data packet is selected while maintaining communication efficiency.

At operation S203, the master controller reports the target second audio data packet to the host processor. Specifically, the master controller transmits the target second audio data packet via the HCl interface. If the target slave controller fails to correctly receive the second audio data packet, the master controller instead reports an indication of incorrect reception to the host processor, informing it that the transmission from the audio transmitting device was unsuccessful. Additionally, in this embodiment, real-time channel quality detection is performed. When the channel quality meets a second preset condition, the transceiver function of the target slave controller is disabled, and the transceiver function of the master controller is reenabled.

The second preset condition is defined as follows: the second channel quality (associated with the slave controller) falls below the first preset threshold, and the first channel quality (associated with the master controller) exceeds the second preset threshold. When these conditions are met, the system switches back to the master controller for receiving the second audio data packet (BIS PDU2).

Furthermore, the wireless audio data transmission method includes an additional transition: when the third preset condition is met, the scalable controller switches from the second working mode to the first working mode. The third preset condition is: the first channel quality (master controller) is below the first preset threshold; and the second channel quality (slave controller) is also below the first preset threshold. When both controllers experience poor channel quality, the SCISA receiving device switches to the first working mode (Cooperation Spatial Diversity Mode), enabling both the master and slave controllers to work simultaneously. This increases the number of retransmissions, ensuring stable communication performance and improving the transmission reliability of isochronous stream audio.

For the detailed transmission and reception process in the first working mode, please refer to the previously described embodiment. In this embodiment, the scalable controller also supports a third working mode for isochronous stream audio transmission, referred to as the default mode. In this mode, only the master controller operates, while the slave controllers remain in a power-down state. Specifically, in the third working mode, the wireless audio data transmission method includes the following operations: the master controller continuously receives a third audio data packet, such as BIS PDU3, transmitted by the audio transmitting device; the master controller determines the target third audio data packet based on its reception status; the correctly received target third audio data packet is reported to the host processor; and if the third audio data packet is not correctly received, the master controller reports an indication of incorrect reception to the host processor. This third working mode is applicable in favorable wireless environments, characterized by short communication distances, minimal channel fading, and low interference levels.

The above-described audio data transmission method operates based on the BIG link of the WBA system. Therefore, before transmitting the audio data packet, the process includes: the master controller establishing an isochronous stream communication link with the audio transmitting device and communicating over this link; and at least one slave controller sharing the isochronous stream communication link and also communicating with the audio transmitting device. The isochronous stream communication link may be a point-to-multipoint isochronous stream communication link. Additionally, this link may function as a Broadcast Isochronous Group (BIG) link.

In the wireless audio data transmission method provided in one embodiment, the SCISA receiving device adopts a scalable controller structure, consisting of a host processor and a scalable controller. The scalable controller includes a master controller and one or more scalable slave controllers. During the transmission of isochronous stream audio data, the scalable controller dynamically employs one or more slave controllers to assist the master controller in receiving the audio data packets from the transmitting device. Compared to a setup where only the master controller handles reception, this method increases the equivalent number of retransmissions, thereby enhancing communication performance and transmission reliability for isochronous stream audio.

Additionally, this method requires no significant modifications to the transmitting device or chip design, offering improved scalability. One or more slave controllers can be added as needed to enhance reception performance, and the system can dynamically enable or disable controllers based on real-time changes in the communication environment.

The key difference between the second embodiment and the previously described first embodiment is that the second embodiment applies the SCISA receiving method to a WLLA system (as shown in FIG. 2). In this case, communication between the WLLA master device and the SCISA receiving device occurs via a CIG link.

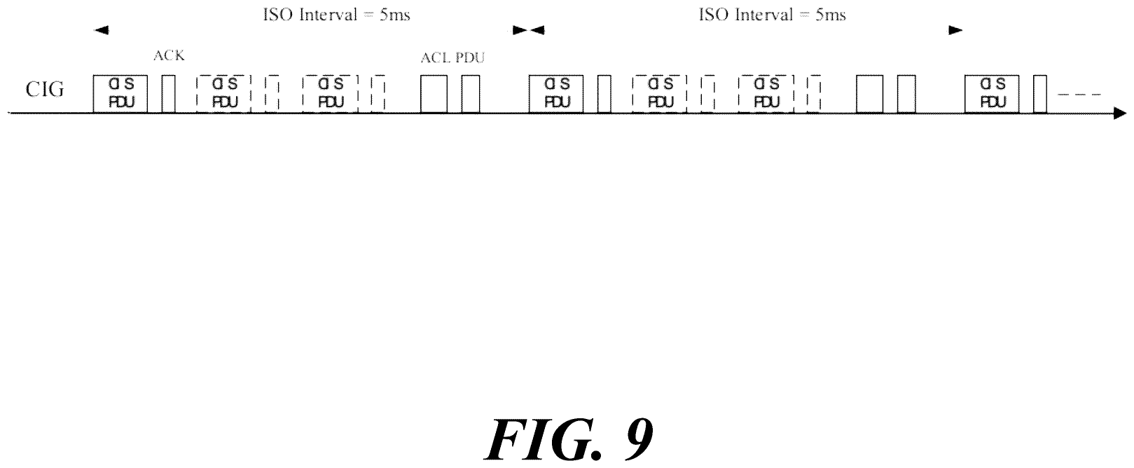

In one possible embodiment, the WLLA master device is a game console, and the SCISA slave device is a gaming headset. The game console and gaming headset establish a CIG link to transmit audio data. FIG. 9 illustrates a timing diagram of the CIG link between the game console and the gaming headset. The diagram also depicts a BLE ACL link and a CIS link, wherein: the isochronous interval (ISO Interval) of the CIG link is 5 ms; ACL PDU represents BLE ACL link transmission and reception; and CIS PDU and ACK PDU represent transmission and reception in the CIG link. In this embodiment, the WLLA master device functions as the audio transmitting device, while the SCISA slave device serves as the SCISA receiving device. The isochronous stream communication link between them is a point-to-point isochronous stream communication link, specifically a Connected Isochronous Group (CIG) link.

In a specific embodiment, the main parameters of the CIG link established between the WLLA master device and the WLLA slave device (i.e., the SCISA receiving device) include, without limitation, at least one of the following: LC3 encoding frame length: 5 ms with a sampling rate of 48 kHz; stereo channel encoding rate: 128 kbps per channel; Stereo Service Data Unit (SDU) size: 160 bytes; CIG isochronous interval (ISO Interval): 5 ms; number of CIS links: 1; number of Sub-Events (NSE): 3; Burst Number (BN): 1; and Flush Time (FT): 1.

The BLE ACL link between the WLLA master and slave devices operates over a BLE 1 Mbps physical layer, while the CIG link operates over a BLE 2 Mbps physical layer. The BLE ACL link occupies a 1.25 ms time slot, leaving 3.75 ms of the 5 ms ISO Interval for the CIG link. Additional transmission characteristics includes, without limitation, at least one of the following: CIS PDU air time: 700 μs; T_IFS (Time Interframe Space): 150 μs; WLLA slave device acknowledgment (ACK) air time: 44 μs; and subevent interval: 1080 μs; and total air time for three subevents: 3.24 ms. Each CIS PDU can be transmitted up to three times, meaning it is only retransmitted twice. Due to performance limitations in fading and interference-prone environments, WLLA slave device reception may be unreliable. Therefore, improving reception performance is essential.

To enhance reception performance, this embodiment employs the SCISA receiving device, as illustrated in FIG. 4. The SCISA receiving device incorporates a scalable controller consisting of a master controller and a slave controller. Both controllers are integrated into the same SOC chip, but their antenna pins are positioned on opposite sides. This increases the spatial distance between the two antennas, reducing the signal fading correlation coefficient and achieving greater spatial diversity gain.

Furthermore, in this embodiment, the SCISA receiving device functions as a gaming headset. To optimize spatial diversity further, the gaming headset may use two separate SOC chips, in one embodiment: one SOC chip encapsulating the host processor and master controller is placed in the left ear cup; and another SOC chip encapsulating the slave controller is placed in the right ear cup. In an alternate embodiment, the gaming headset may use a single SOC chip communicatively coupled o both the left ear cup and the right ear cup. By maintaining a sufficient spatial distance between the master and slave controllers, the system effectively minimizes signal fading correlation and achieves maximum spatial diversity gain, significantly improving audio transmission reliability.

The scalable controller of the SCISA receiving device operates in three distinct working modes: the first working mode, also described here in as the cooperation Spatial Diversity Mode; the second working mode, also described herein as the Selective Spatial Diversity Mode; and the third working mode or the default mode. The processes for these three modes are similar to those described in am above embodiment.

In optimal wireless conditions—such as short communication distances, minimal channel fading, and low interference—the default mode is used. In this mode, only the master controller is active, while the slave controller remains in a power-down state, functioning similarly to a standard WLLA slave device using the CIG link.

When wireless conditions change and using only the master controller cannot meet communication performance requirements, while the slave controller can, the system switches to the Selective Spatial Diversity Mode. This mode selectively enables either the master or slave controller based on real-time wireless conditions. If multiple slave controllers are present, any one of them can be activated as needed.

If the wireless environment suffers from deep fading and strong interference, and Selective Spatial Diversity Mode is insufficient, the system transitions to Cooperation Spatial Diversity Mode. In this mode, both the master controller and slave controller are simultaneously active. They receive the CIS PDU at the same time and merge the received data packets to improve reliability and performance.

According to the Bluetooth Low Energy (BLE) protocol, a CIG slave device first establishes a BLE ACL connection with the CIG master device, then uses this connection to establish a CIG link. In this embodiment, the master controller of the SCISA receiving device is responsible for setting up the BLE ACL connection with the WLLA master device. Once the CIG link is established, if the slave controller needs to be enabled, the master controller transmits CIG link information to the slave controller through the interface between the master and slave controllers. This allows the slave controller to synchronize with the CIG link of the WLLA master device, ensuring smooth communication and data reception.

Regarding the three working modes of the SCISA receiving device, the third working mode, or default mode, operates similarly to a standard WLLA slave device using the CIG link. Therefore, this mode does not require further elaboration. The following sections describe the specific receiving methods for the first working mode (Cooperation Spatial Diversity Mode) and the second working mode (Selective Spatial Diversity Mode).

In Selective Spatial Diversity Mode, the master controller maintains the BLE ACL connection with the WLLA master device and transmits CIG link information to the slave controller. This allows the slave controller to synchronize with the CIG link of the WLLA master device and assist in reception when needed.

During CIG link communication, in Cooperation Spatial Diversity Mode, the master controller sends an initial acknowledgment to the audio transmitting device via the CIG link. This acknowledgment indicates whether the master controller has successfully received the first audio data packet. If the master controller correctly receives the first audio data packet from the audio transmitting device, it responds with an ACK (Acknowledgment). If the master controller does not correctly receive the first audio data packet, it responds with a NAK (Negative Acknowledgment). Upon receiving an ACK from the master controller, the audio transmitting device ceases transmission of the first audio data packet (e.g., CIS PDU packet). Conversely, if the audio transmitting device receives a NAK, it continues retransmitting the CIS PDU packet until successfully received.

Similarly, in the third working mode (Default Mode), the master controller maintains the CIG connection with the WLLA master device and is responsible for responding with ACK/NAK to the audio transmitting device. Additionally, the SCISA receiving device continuously evaluates the wireless channel quality between: the master controller and the WLLA master device; and the slave controller and the WLLA master device. For channel quality evaluation, the system measures the Packet Error Rate (PER) of received CIS PDUs—where lower PER values indicate better channel quality. By dynamically selecting the appropriate working mode based on real-time channel conditions, the system optimizes reception and ensures reliable audio transmission.

Optionally, the master controller is initially responsible for receiving the CIS PDU packet and replying with an acknowledgment. However, if the master controller's channel quality deteriorates—for example, when the first channel quality falls below the first preset threshold, while the slave controller's channel quality is better and exceeds the second preset threshold—the system transitions to the second working mode.

### Second Working Mode Transition

In Selective Spatial Diversity Mode (Second Working Mode), the target slave controller is enabled to receive the CIS PDU packet (e.g., the second audio data packet). The slave controller replies with a second acknowledgment (ACK/NAK) to the audio transmitting device. This second acknowledgment informs the audio transmitting device whether the first audio data packet was correctly received. During this process, the master controller remains active only for BLE ACL connection maintenance or CIG link synchronization with the WLLA master device for periodic channel quality evaluation.

The second preset threshold is set higher than the first preset threshold. When channel quality is measured using PER (Packet Error Rate), the first and second preset thresholds are defined as reciprocal values of the PER. If the target slave controller's channel quality deteriorates (i.e., falls below the first preset threshold) and the master controller's channel quality improves (i.e., exceeds the second preset threshold), the system switches back to the master controller for receiving the CIS PDU packet and responding with the second acknowledgment (ACK/NAK).

Similarly, when the target slave controller receives the CIS PDU packet, it transmits the correctly received packet to the master controller via the HCl interface. The master controller then submits the CIS PDU packet to the host processor. If the channel quality of both the master and slave controllers deteriorates and falls below the first preset threshold, the SCISA receiving device transitions back to the first working mode (Cooperation Spatial Diversity Mode) to ensure robust audio transmission and increased retransmission opportunities.

In the first working mode (Cooperation Spatial Diversity Mode), both the master controller and slave controller remain synchronized with the CIG link of the WLLA master device while simultaneously receiving CIS PDU packets from the WLLA master device (audio transmitting device). Either the master controller or slave controller responds with an acknowledgment (ACK/NAK). In this embodiment, the master controller is designated to reply with the acknowledgment.

The slave controller transmits the received CIS PDU packets to the master controller via the HCl interface. The master controller then merges its own received CIS PDU packets with those received from the slave controller before submitting them to the host processor.

The merging of the received CIS PDU packets means, in one example that when both the master controller and slave controller correctly receive the CIS PDU packets, the master controller selects any one of the correctly received packets for submission to the host processor. If only one of the controllers correctly receives the CIS PDU packet, the master controller submits the correctly received packet to the host processor. If neither controller correctly receives the CIS PDU packet, the master controller reports a reception failure to the host processor and simultaneously sends a NAK to the WLLA master device, indicating that the CIS PDU packet was not successfully received. The process of receiving the CIS PDU packet and reporting it to the host processor in the second embodiment follows the same methodology as described in the first embodiment and is not repeated here. Since the likelihood of both the master and slave controllers failing to receive the CIS PDU packet simultaneously is significantly reduced due to independent spatial fading, utilizing Cooperation Spatial Diversity Mode can greatly enhance the receiving performance of the SCISA receiving device.

It should be noted that the master controller may successfully receive the CIS PDU and send an acknowledgment (ACK) after receiving it once or twice (less than NSE) within the current ISO Interval. In such cases, the WLLA master device stops transmitting the CIS PDU, limiting the slave controller to only one or two additional reception attempts. If the master controller fails to correctly receive the CIS PDU after NSE attempts within the ISO Interval, the slave controller also gets NSE attempts to receive it. This increases the probability that at least one controller will successfully receive the CIS PDU within the interval. Thus, in this embodiment, while both the master controller and slave controller individually have at most three reception attempts for the same CIS PDU (NSE=3), the SCISA receiving device, which consists of both controllers, effectively extends this to six reception attempts. This setup provides an equivalent retransmission increase, as if the NSE value were doubled to 6. Without requiring the WLLA master device to increase the number of CIS PDU transmissions, this approach significantly enhances communication reliability. Furthermore, it achieves these improvements without necessitating modifications to the transmitting device or chip design.

In the third embodiment, a scalable controller (as shown in FIG. 3) is introduced. The scalable controller consists of a master controller and at least one slave controller. The master controller, includes, without limitation: a first interface, defined by the Bluetooth Core Specification, which connects to an external host processor; and a second interface, also defined by the Bluetooth Core Specification, which connects to at least one slave controller. As illustrated in FIG. 3, multiple slave controllers (1 to M) are connected in a cascaded/series configuration, enabling a flexible and scalable architecture for efficient data transmission.

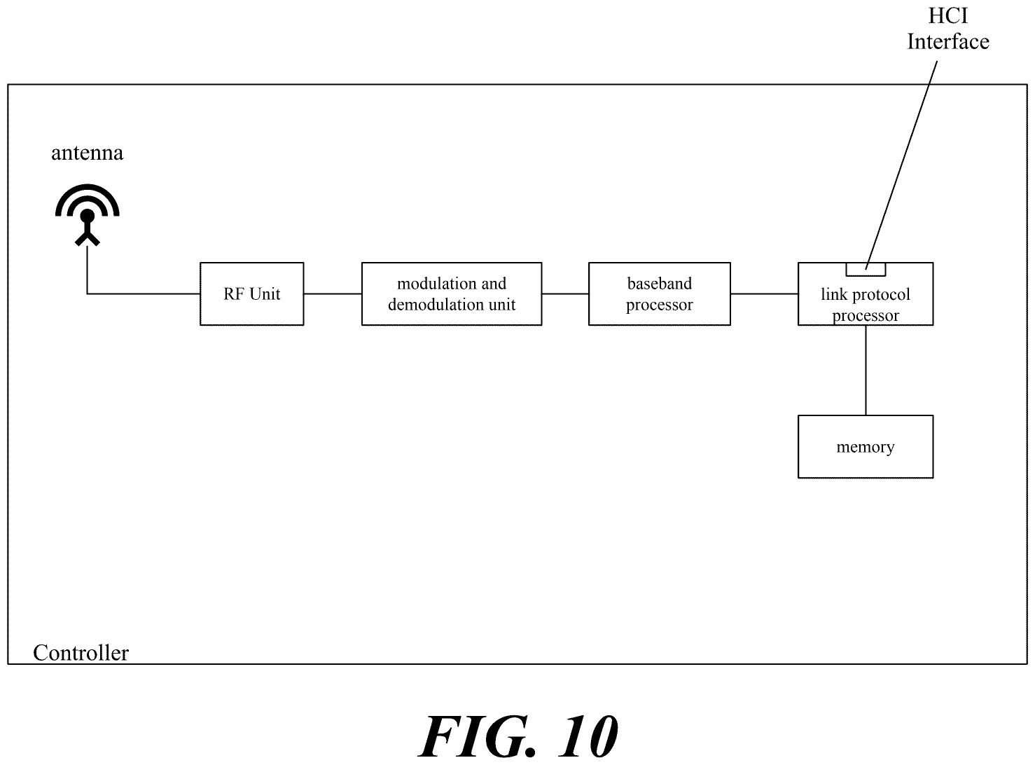

FIG. 10 is a schematic structural diagram of a controller according to one embodiment of the present invention. The controller in FIG. 10 may function as either the master controller or a slave controller. The controller includes, without limitation, at least one of the following: an antenna; a radio frequency unit; a modulation and demodulation unit; a baseband processor; a link protocol processor; and a memory. The master controller is equipped with one or more antennas to receive audio data packets transmitted by the audio transmitting device. Similarly, each slave controller is equipped with one or more antennas for the same purpose. To minimize interference, the master controller's antenna is isolated from the antennas of the slave controllers. The radio frequency unit, modulation and demodulation unit, baseband processor, link protocol processor, and memory are all designed to execute the wireless audio data transmission method described in previous embodiments.

In an embodiment, the link processor includes, without limitation, at least one of the following: a first interface connected, or communicatively coupled, to an external host processor; and a second interface—connected, or communicatively coupled, to one or more slave controllers. In an embodiment, the number of second interfaces is greater than or equal to 1. If the master controller is cascaded with M slave controllers, it can establish a connection through a single second interface. However, if the master controller is connected in parallel with M slave controllers, it must establish M independent second interfaces, where M≥2.

In an embodiment, the memory may serve multiple functions, including, without limitation: storing transmission data (such as, audio data packets); and storing computer-readable program instructions, enabling a computer to execute any of the wireless audio data transmission data methods described herein.

In one embodiment, the master controller and at least one slave controller are integrated into the same chip. The antenna pins of the master controller and the slave controller are placed on opposite sides of the chip. This spatial separation ensures a low fading correlation coefficient for received signals, thereby enhancing spatial diversity gain. A receiving device, as described in the third embodiment, is also provided. As shown in FIG. 3, the receiving device includes, without limitation, at least one of the following: a host processor; and a scalable controller. The host processor is connected, or communicatively coupled, to the first interface of the scalable controller, which conforms to the Bluetooth Core Specification for seamless integration into wireless communication systems. The scalable controller is designed to execute the wireless audio data transmission methods described in previous embodiments. The host processor receives the target audio data packets transmitted by the scalable controller through the first interface. It should be noted that in the third embodiment, the master controller or slave controller may include additional or fewer units/modules, and this embodiment does not impose limitations on such configurations.

A wireless audio data transmission device is also provided in the third embodiment. This device is used to implement the wireless audio transmission methods described in prior embodiments and preferred implementations. To avoid redundancy, previously described details will not be repeated. In this context, the term “unit” refers to a combination of software and/or hardware that performs a predefined function. While the device described in the following embodiments is primarily implemented using software, implementations using hardware or a hybrid of software and hardware are also considered.

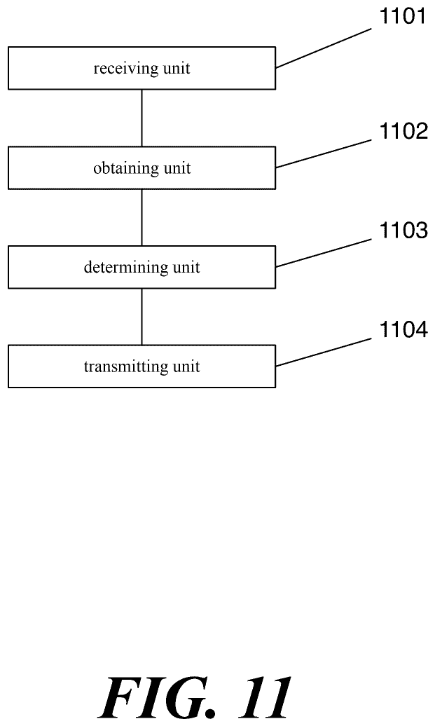

FIG. 11 illustrates an exemplary block diagram of a wireless audio data transmission device according to one embodiment of the present invention. The wireless audio transmission device comprises a receiving unit 1101, an obtaining unit 1102, a determining unit 1103 and a transmitting unit 1104. The receiving unit 1101 is configured to receive the first audio data packet transmitted by the audio transmitting device after the controller is enabled. The obtaining unit 1103 is configured to retrieve the reception status of the first audio data packet from at least one enabled slave controller and reports the status to the master controller, wherein the slave controller synchronously receives the first audio data packet when enabled. The determining unit 1103 is configured to determine the target first audio data packet based on its own reception status and the status reported by the enabled slave controller. The target first audio data packet is the correctly received version of the packet. The transmitting unit 1104 is configured to report the target first audio data packet to the host processor.

In an embodiment, the determining unit 1103 operates under the following conditions: if the receiving unit (1101) correctly receives the first audio data packet, the determining unit (1103) selects this as the target first audio data packet; if the receiving unit (1101) fails to correctly receive the first audio data packet, but the slave controller successfully receives and reports it, the determining unit (1103) selects the slave controller's version of the first audio data packet as the target first audio data packet; or if neither the receiving unit (1101) nor the enabled slave controller receives the first audio data packet, the determining unit (1103) generates an indication of failed reception and reports this to the host processor via the transmitting unit (1104). Further functional details of each unit align with those described in the corresponding embodiments and will not be repeated here. As will be well known to those of ordinary skill in the art, it should be noted that the wireless audio data transmission device applies to both the master controller and the slave controller, and this embodiment does not impose limitations on its applicability.

Program code for implementing the methods of the present invention may be written in any combination of one or more programming languages. This program code may be provided to a processor or controller of a general-purpose computer, a specialized computer, or another programmable data processing device. When executed by the processor or controller, the program code causes the functions and operations outlined in the flowchart and/or block diagram to be implemented. The program code may be executed entirely on the machine, partially on the machine, partially on the machine as a standalone software package and partially on a remote machine or entirely on a remote machine or server.

In one embodiment, the present invention also provides a computer-readable storage medium having a computer program stored thereon. When the computer program is executed by a processor to realize the BLE broadcast communication method in the above-described embodiments and can achieve the same technical effect, which will not be repeated herein in order to avoid repetition. The computer-readable storage medium can be a read only memory (ROM), random access memory (RAM), magnetic disc or optical disc, etc.

The embodiments of this application are described above in conjunction with the accompanying drawings. However, this application is not limited to the specific embodiments provided. These embodiments serve as illustrative examples rather than restrictions. A person of ordinary skill in the field may introduce modifications without departing from the purpose and protection scope of the claims.

While preferred embodiments of the present invention have been detailed, additional changes and modifications may be introduced once the fundamental concepts are understood by those skilled in the art. The appended claims are intended to encompass preferred embodiments as well as all changes and modifications that fall within the scope of this application.

Clearly, a person skilled in the art may introduce various changes and variations to the application while still maintaining its spirit and scope. Therefore, if these modifications align with the scope of the claims and their equivalent technologies, they are intended to be included within the scope of this application.

What is claimed is:

1. A wireless audio data transmission method applied to a scalable controller comprising a master controller and at least one slave controller, comprising:
operating the scalable controller in a first working mode during isochronous stream audio transmission;
receiving, by the master controller, a first audio data packet transmitted by an audio transmitting device when the master controller is enabled, and obtaining, by the master controller, a reception status of the first audio data packet from at least one slave controller that is enabled to receive synchronously the first audio data packet transmitted by the audio transmitting device and report the reception status of the first audio data packet to the master controller;
determining, by the master controller, a target first audio data packet based on a reception status of the first audio data packet transmitted by the audio transmitting device when the master controller is enabled, and the reception status reported by the enabled slave controller, the target first audio data packet being the first audio data packet that is correctly received; and
reporting, by the master controller, the target first audio data packet to a host processor.

2. The method according to claim 1, wherein:
the reception status from the at least one slave controller comprises the first audio data packet when the first audio data packet is correctly received by the at least one slave controller that is enabled to receive synchronously the first audio data packet; and
the reception status from the at least one slave controller comprises an indication that the first audio data packet was not received correctly when the first audio data packet is not correctly received by the at least one slave controller that is enabled to receive synchronously the first audio data packet.

3. The method according to claim 1, wherein determining, by the master controller, a target first audio data packet based on a reception status of the first audio data packet of the master controller, and the reception status reported by the enabled slave controller, includes:
selecting, by the master controller, the first audio data packet correctly received by the master controller as the target first audio data packet if the master controller correctly receives the first audio data packet; or
selecting, by the master controller, the first audio data packet reported by the slave controller as the target first audio data packet if the first audio data packet is not correctly received by the master controller and the enabled slave controller correctly receives and reports the first audio data packet.

4. The method according to claim 1, further comprising:
reporting, by the master controller, an indication to the host processor that the first audio data packet has not been correctly received to the host processor when both the master controller does not correctly receive the first audio data packet and the enabled slave controller does not receive the first audio data packet correctly.

5. The method according to claim 1, further comprising:
operating the scalable controller in a second working mode during the isochronous stream audio transmission; and
selectively enabling the master controller or a target slave controller for transmitting or receiving the audio data packet based on wireless channel quality, wherein the target slave controller is one of the at least one slave controller.

6. The method of claim 5, wherein if the master controller is enabled while the scalable controller is operating in the second working mode, the method further comprises:
receiving, by the master controller, a second audio data packet transmitted by the audio transmitting device when the master controller is enabled;
determining, by the master controller, a target second audio data packet based on the reception status of the second audio data packet of the enabled master controller, the target second audio data packet being the second audio data packet transmitted by the audio transmitting device and correctly received;
reporting, by the master controller, the target second audio data packet to the host processor; and
disabling a transceiver function of the master controller, enabling the target slave controller and maintaining data synchronization and channel evaluation between the master controller and the audio transmitting device when:
a first channel quality is less than a first preset threshold, wherein the first channel quality is a channel quality of the master controller; and
a second channel quality is greater than a second preset threshold, wherein the second channel quality is a channel quality of the target slave controller and is greater than the first preset threshold.

7. The method according to claim 6 if the target slave controller is enabled while the scalable controller is operating in the second working mode, the method further comprises:
receiving, by the target slave controller, the second audio data packet transmitted by the audio transmitting device and reporting the reception status to the master controller;
determining, by the master controller, the target second audio data packet based on the reception status reported by the target slave controller, wherein the target second audio data packet is the correctly received second audio data packet;
reporting, by the master controller, the target second audio data packet to the host processor; and
disabling a transceiver function of the target slave controller and reenabling the transceiver function of the master controller if the second channel quality falls below the first preset or the first channel quality rises above the second preset threshold.

8. The method according to claim 6, further comprising:
switching the scalable controller from the second working mode to the first working mode when:
the first channel quality is less than the first preset threshold; and
the second channel quality is less than the first preset threshold.

9. The method according to claim 1, wherein while the scalable controller is operating in a third working mode, the method further comprising:
receiving, by the master controller, a third audio data packet transmitted by the audio transmitting device continuously;
determining, by the master controller, a target third audio data packet based on the reception status of the third audio data packet, wherein the target third audio data packet is the correctly received third audio data packet; and
reporting, by the master controller, the target third audio data packet to the host processor.

10. The method of claim 5, wherein the scalable controller operates in different working modes during the isochronous stream audio transmission, the method further comprising:
establishing an isochronous stream communication link between the master controller and the audio transmitting device and communicating with the audio transmitting device based on the isochronous stream communication link; and
sharing the isochronous stream communication link and communicating with the audio transmitting device based on the isochronous stream communication link by the at least one slave controller, wherein the isochronous stream communication link is at least one of the following: a point-to-point isochronous stream communication link, or a point-to-multipoint communication link.

11. The method according to claim 10, wherein the point-to-point isochronous stream communication link is a Connected Isochronous Group (CIG) link; and the point-to-multipoint isochronous stream communication link is a Broadcast Isochronous Group (BIG) link.

12. The method according to claim 11, wherein during communication via the CIG link, the method further comprising:
the master controller transmits a first acknowledgment to the audio transmitting device via the CIG link in the first working mode, wherein the first acknowledgment indicates whether the first audio data packet was correctly received.

13. The method according to claim 11, wherein during communication via the CIG link, the method further comprising:
transmitting, by the master controller or the target slave controller, a second acknowledgment to the audio transmitting device via the CIG link in the second working mode, the second acknowledgment message indicating whether the second audio data packet was correctly received.

14. The method according to claim 1, wherein the master controller comprises a first interface and a second interface defined by a Bluetooth core specification, wherein the first interface connects to the host processor and the second interface connects to the at least one slave controller, the method further comprising:
receiving, by the master controller, the reception status reported by the enabled slave controller via the second interface; and
reporting, by the master controller, the target first audio data packet to the host processor via the first interface.

15. The method according to claim 14, wherein the at least one slave controller is connected to the master controller either in series or in parallel.

16. The method according to claim 1, wherein the master controller is provided with one or more corresponding antennas; at least one of the one or more slave controllers is provided with one or more corresponding antennas; and the antennas corresponding to the master controller and the at least one of the one or more slave controllers are spatially separated from each other.

17. A scalable controller, comprising:
a master controller and at least one slave controller, wherein the master controller comprises a first interface and a second interface defined by a Bluetooth Core Specification, the first interface communicatively coupled to a host processor located outside the scalable controller, and the second interface communicatively coupled to the at least one slave controller;
the master controller is provided with one or more corresponding antennas configured to receive an audio data packet transmitted by an audio transmitting device, and each slave controller is provided with one or more corresponding antennas configured to receive the audio data packet transmitted by the audio transmitting device, wherein the corresponding antennas of the master controller and the corresponding antennas of each slave controller are spatially separated;
wherein, the master controller and each slave controller comprise a radio frequency unit, a modulation and demodulation unit, a baseband processor, a link processor and a memory; and
wherein the master controller is configured to perform the following method:
operating the scalable controller in a first working mode during isochronous stream audio transmission;
receiving, by the master controller, a first audio data packet transmitted by an audio transmitting device when the master controller is enabled, and obtaining, by the master controller, a reception status of the first audio data packet from at least one slave controller that is enabled to receive synchronously the first audio data packet transmitted by the audio transmitting device and report the reception status of the first audio data packet to the master controller;
determining, by the master controller, a target first audio data packet based on a reception status of the first audio data packet transmitted by the audio transmitting device when the master controller is enabled, and the reception status reported by the enabled slave controller, the target first audio data packet being the first audio data packet that is correctly received; and
reporting, by the master controller, the target first audio data packet to a host processor.

18. The scalable controller according to claim 17, wherein the master controller and the at least one slave controller are encapsulated within a single chip and antenna pins of the master controller and the at least one slave controller are disposed on two opposing surfaces of the single chip.

19. A receiving device, comprising:
a host processor;
a scalable controller connected to the host processor via a first interface defined by a Bluetooth Core Specification, wherein the scalable controller comprises a master controller and at least one slave controller and is configured to perform the following operations:
operating the scalable controller in a first working mode during isochronous stream audio transmission;
receiving, by the master controller, a first audio data packet transmitted by an audio transmitting device when the master controller is enabled, and obtaining, by the master controller, a reception status of the first audio data packet from at least one slave controller that is enabled to receive synchronously the first audio data packet transmitted by the audio transmitting device and report the reception status of the first audio data packet to the master controller;
determining, by the master controller, a target first audio data packet based on a reception status of the first audio data packet transmitted by the audio transmitting device when the master controller is enabled, and the reception status reported by the enabled slave controller, the target first audio data packet being the first audio data packet that is correctly received; and
reporting, by the master controller, the target first audio data packet to a host processor; and
the host processor is configured to receive the target audio data packet transmitted by the scalable controller via the first interface.

20. The receiving device according to claim 19,
the reception status from the at least one slave controller comprises the first audio data packet when the first audio data packet is correctly received by the at least one slave controller that is enabled to receive synchronously the first audio data packet; and
the reception status from the at least one slave controller comprises an indication that the first audio data packet was not received correctly when the first audio data packet is not correctly received by the at least one slave controller that is enabled to receive synchronously the first audio data packet.
